(19) United States
(12) Patent Application Publication
(10) Pub. No.: US 2023/0344940 A1
(43) Pub. Date: Oct. 26, 2023

(54) PERSONALIZED AUTO VOLUME ADJUSTMENT DURING DIGITAL CONFERENCING MEETINGS

(71) Applicant: Avaya Management L.P., Durham, NC (US)

(72) Inventors: Pushkar Deole, Pune (IN); Muskan Pandey, Mumbai (IN); Sandesh Chopdekar, Kondhwa (IN)

(21) Appl. No.: 17/727,572

(22) Filed: Apr. 22, 2022

(51) Int. Cl. H04M 3/56; G10L 21/034; G10L 25/51; G06F 3/16; G06T 11/00

(52) U.S. Cl. CPC H04M 3/563; G10L 21/034; G10L 25/51; G06F 3/165; G06T 11/00; H04M 3/568; H04M 2203/256

(57) ABSTRACT

The systems and method of the present disclosure provide for automatic volume adjustment during a communication session. The method includes receiving an entered volume level, receiving at least one audio signal from a communication session, analyzing a volume level of the at least one audio signal, and comparing the entered volume level with the volume level of the at least one audio signal. The method also includes determining that the entered volume level does not match the volume level of the at least one audio signal and when the entered volume level does not match the volume level of the at least one audio signal, adjusting the volume level of the at least one audio signal to match the entered volume level.

### FIELD

The present disclosure relates generally to systems and methods for multi-participant communication sessions, popularly known as conferencing and particularly relates to systems and methods for automatically adjusting the volume of audio signals from participants during multi-participant communication conferencing.

### BACKGROUND

As remote working becomes the new normal, work meetings (e.g., multi-participant communication conferencing) through web conferencing applications are on the rise. With this new normal, however, the remote working community has begun to realize the following problems associated with conducting meetings remotely. One of the prominent problems associated with conducting meetings remotely is addressing the varying degrees in volume of the voice of a participant that is speaking during the meeting. The sound of the participant's voice, may vary in many properties, including but not limited to volume, pitch, pace and frequency. For example, the participant may speak with a high volume or high speech intensity. This could be the result of the participant having a naturally loud or strong voice or could be the result of the participant being too close to the microphone while speaking. On the other hand, a participant may speak with a low volume or low speech intensity (due to being far away from the microphone, for example). Therefore, the intensity at which the audio representing the voice of the participant reaches the other participants varies greatly.

A second problem associated with conducting meetings remotely is addressing ambient or background noise. For example, some participants might be speaking in an environment that is surrounded by ambient noise and although artificial intelligence (AI) noise removal techniques may be employed, whenever there is surrounding noise in close proximity to the participant, the surrounding noise masks the participant's voice. Due to the masking of the participant's voice, the volume of the participant's voice diminishes as it reaches the other participants.

Conventionally, the only way to solve these problems is to continuously adjust the volume of an audio output device (e.g., handset, speaker, etc.) of the receiving participant in order to receive the audio signal consistently at a preferred volume. This continuous adjustment of the audio output device must be performed manually. Moreover, adjusting the audio output device continuously and manually during a communication session, shifts the focus of the receiving participants from discussing topics and receiving information to devising trouble-shooting techniques for receiving the audio signal at the preferred volume.

Therefore, there is a need for systems and methods for automatically adjusting the volume of audio signals from participants during multi-participant communication conferencing.

### SUMMARY

These and other needs are addressed by the various embodiments and configuration of the present disclosure. The present disclosure can provide a number of advantages depending on the particular configuration. These and other advantages will be apparent from the disclosure contained therein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “conference” as used herein refers to any communication session or set of communications, whether including audio, video, text, or other multimedia data, between two or more communication endpoints and/or users. Typically, a conference includes two or more communication endpoints. The terms “conference” and “conference call” are used interchangeably throughout the specification.

The term “communication device” or “communication endpoint” as used herein refers to any hardware device and/or software operable to engage in a communication session. For example, a communication device can be an Internet Protocol (IP)-enabled phone, a desktop phone, a cellular phone, a personal digital assistant, a soft-client telephone program executing on a computer system, etc. IP-capable hard- or softphone can be modified to perform the operations according to embodiments of the present disclosure.

The term “network” as used herein refers to a system used by one or more users to communicate. The network can consist of one or more session managers, feature servers, communication endpoints, etc. that allow communications, whether voice or data, between two users. A network can be any network or communication system as described in conjunction with FIG. 1. Generally, a network can be a LAN, a wide area network (WAN), a wireless LAN, a wireless WAN, the Internet, etc. that receives and transmits messages or data between devices. A network may communicate in any format or protocol known in the art, such as, transmission control protocol/internet protocol (TCP/IP), 802.11g, 802.11n, Bluetooth, or other formats or protocols.

The term “communication event” and its inflected forms includes: (i) a voice communication event, including but not limited to a voice telephone call or session, the event being in a voice media format, or (ii) a visual communication event, the event being in a video media format or an image-based media format, or (iii) a textual communication event, including but not limited to instant messaging, internet relay chat, e-mail, short-message-service, Usenet-like postings, etc., the event being in a text media format, or (iv) any combination of (i), (ii), and (iii).

The term “communication system” or “communication network” and variations thereof, as used herein, can refer to a collection of communication components capable of one or more of transmission, relay, interconnect, control, or otherwise manipulate information or data from at least one transmitter to at least one receiver. As such, the communication may include a range of systems supporting point-to-point or broadcasting of the information or data. A communication system may refer to the collection of individual communication hardware as well as the interconnects associated with and connecting the individual communication hardware. Communication hardware may refer to dedicated communication hardware or may refer a processor coupled with a communication means (i.e., an antenna) and running software capable of using the communication means to send and/or receive a signal within the communication system. Interconnect refers some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium” as used herein refers to any tangible storage and/or transmission medium that participate in providing instructions to a processor for execution. The computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, etc. Such a medium may take many forms, including but not limited to, non-volatile media, volatile media, and transmission media. Non-volatile media includes, for example, non-volatile random-access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

A “database” is an organized collection of data held in a computer. The data is typically organized to model relevant aspects of reality (for example, the availability of specific types of inventory), in a way that supports processes requiring this information (for example, finding a specified type of inventory). The organization schema or model for the data can, for example, be hierarchical, network, relational, entity-relationship, object, document, XML, entity-attribute-value model, star schema, object-relational, associative, multidimensional, multi-value, semantic, and other database designs. Database types include, for example, active, cloud, data warehouse, deductive, distributed, document-oriented, embedded, end-user, federated, graph, hypertext, hypermedia, in-memory, knowledge base, mobile, operational, parallel, probabilistic, real-time, spatial, temporal, terminology-oriented, and unstructured databases. “Database management systems” (DBMSs) are specially designed applications that interact with the user, other applications, and the database itself to capture and analyze data.

The terms “determine”, “calculate” and “compute,” and variations thereof, are used interchangeably and include any type of methodology, process, mathematical operation or technique.

The term “electronic address” refers to any contactable address, including a telephone number, instant message handle, e-mail address, Universal Resource Locator (URL), Universal Resource Identifier (URI), Address of Record (AOR), electronic alias in a database, like addresses, and combinations thereof.

An “enterprise” refers to a business and/or governmental organization, such as a corporation, partnership, joint venture, agency, military branch, and the like.

A “geographic information system” (GIS) is a system to capture, store, manipulate, analyze, manage, and present all types of geographical data. A GIS can be thought of as a system—it digitally makes and “manipulates” spatial areas that may be jurisdictional, purpose, or application-oriented. In a general sense, GIS describes any information system that integrates, stores, edits, analyzes, shares, and displays geographic information for informing decision making.

The terms “instant message” and “instant messaging” refer to a form of real-time text communication between two or more people, typically based on typed text. Instant messaging can be a communication event.

The term “internet search engine” refers to a web search engine designed to search for information on the World Wide Web and FTP servers. The search results are generally presented in a list of results often referred to as SERPS, or “search engine results pages”. The information may consist of web pages, images, information, and other types of files. Some search engines also mine data available in databases or open directories. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called meta tags). Data about web pages are stored in an index database for use in later queries. Some search engines, such as Google™, store all or part of the source page (referred to as a cache) as well as information about the web pages, whereas others, such as AltaVista™, store every word of every page they find.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

A “server” is a computational system (e.g., having both software and suitable computer hardware) to respond to requests across a computer network to provide, or assist in providing, a network service. Servers can be run on a dedicated computer, which is also often referred to as “the server”, but many networked computers are capable of hosting servers. In many cases, a computer can provide several services and have several servers running. Servers commonly operate within a client-server architecture, in which servers are computer programs running to serve the requests of other programs, namely the clients. The clients typically connect to the server through the network but may run on the same computer. In the context of Internet Protocol (IP) networking, a server is often a program that operates as a socket listener. An alternative model, the peer-to-peer networking module, enables all computers to act as either a server or client, as needed. Servers often provide essential services across a network, either to private users inside a large organization or to public users via the Internet.

The term “social network” refers to a web-based social network maintained by a social network service. A social network is an online community of people, who share interests and/or activities or who are interested in exploring the interests and activities of others.

The term “sound” or “sounds” as used herein refers to vibrations (changes in pressure) that travel through a gas, liquid, or solid at various frequencies. Sound(s) can be measured as differences in pressure over time and include frequencies that are audible and inaudible to humans and other animals. Sound(s) may also be referred to as frequencies herein.

The terms “audio output level” and “volume’ are used interchangeably a refer to the amplitude of sound produced when applied to a sound producing device.

The term “multi-party” as used herein may refer to communications involving at least two parties. Examples of multi-party calls may include, but are in no way limited to, person-to-person calls, telephone calls, conference calls, communications between multiple participants, and the like.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system” Any combination of one or more computer readable medium(s) may be utilized. The computer readable medium may be a computer readable signal medium or a computer readable storage medium.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core i5-4670K and i7-4770K 22 nm Haswell, Intel® Core® 15-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIVI926EJ-S™ processors, other industry-equivalent processors, and may perform computational functions using any known or future-developed standard, instruction set, libraries, and/or architecture.

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a sub element identifier when a sub element identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The present disclosure will be described in conjunction with the appended figures.

FIG. 1 is a block diagram of an illustrative communication system used for automatic volume adjustment during a communication session according to embodiments of the present disclosure.

FIG. 2 is a block diagram of an illustrative conferencing server used for automatic volume adjustment during a communication session according to embodiments of the present disclosure.

FIG. 3 is a block diagram of an illustrative communication device used for automatic volume adjustment during a communication session according to embodiments of the present disclosure.

FIGS. 4A-4D illustrate aspects of automatic volume adjustment interfaces that can be displayed on a communication device used for automatic volume adjustment during a communication session according to embodiments of the present disclosure.

FIG. 5 is a flow diagram of a method used for automatic volume adjustment during a communication session according to embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. Various changes may be made in the function and arrangement of elements without departing from the spirit and scope of the disclosure.

Modern operating systems allow third-party audio hardware manufacturers to include custom digital signal processing effects as part of the audio hardware manufacturers' audio driver's value-added features for audio hardware that does not include an amplifier with an associated physical volume support. As part of the value-added features, the software contains a software algorithm that provides a specific Digital Signal Processing (DSP) effect. This effect or capability is known informally as an “audio effect” which includes automatic gain control among several other effects. The automatic gain control is an audio pre-processor which automatically normalizes the output of the captured input signal by boosting or lowering the input signal to match a preset level so that the output signal is virtually constant. This technique, however, is quite different from allowing a user to automatically adjust the volume of an audio signal to various volume levels during a communication session. The above-mentioned value-added feature of the automatic gain control can be taken a step further even when an amplifier with an associated physical volume support is provided as part of audio hardware on user's device, however, it is not desirable by an end user to use that volume control support such as the case may be as described above in the Background section.

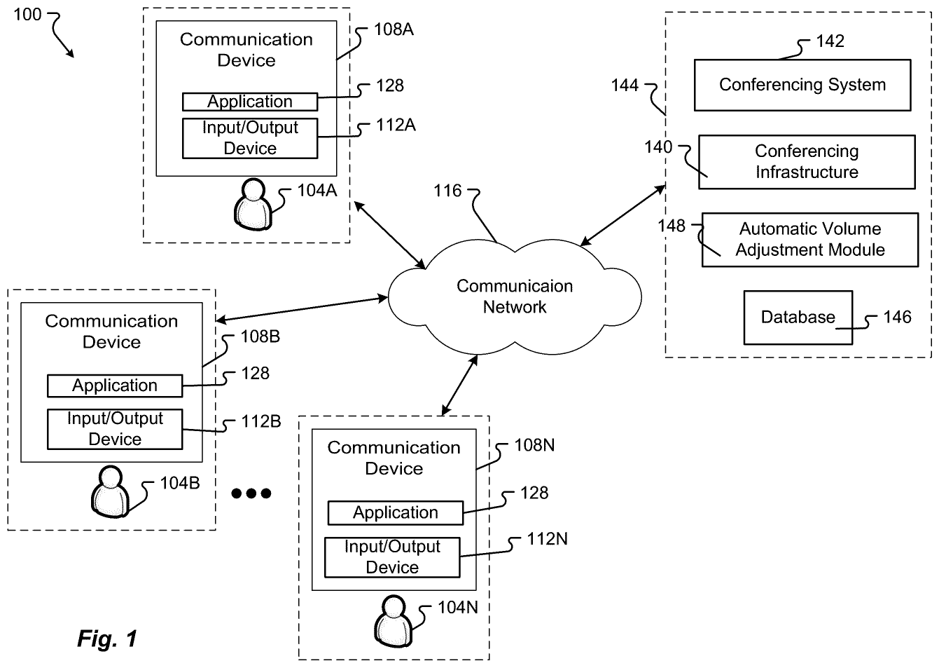

FIG. 1 is a block diagram of an illustrative communication system 100 used for automatic volume adjustment during a communication session according to embodiments of the present disclosure. Referring to FIG. 1, the communication system 100 is illustrated in accordance with at least one embodiment of the present disclosure. The communication system 100 may allow a user 104A to participate in the communication system 100 using a communication device 108A having input/output device 112A. As used herein, communication devices include user devices. Other users 104B to 104N also can participate in the communication system 100 using respective communication devices 108B through 108N having input/output devices 112B to 112N. In accordance with embodiments of the present disclosure, one or more of the users 104A-104N may access a conferencing system 142 utilizing the communication network 116.

As discussed in greater detail below, input/output devices 112A to 112N, may include one or more audio input devices, audio output devices, video input devices and/or video output devices. In some embodiments of the present disclosure, audio input/output devices 112A-112N may be separate from the communication devices 108A-108N. For example, an audio input device may include, but is not limited to, an audio detection microphone that is separate from a receiver microphone used by the communication device 108A to convey local audio to one or more of other communication devices 108B-108N and a conferencing system 142. In some cases, the communication device 108A may include both a detection microphone and another microphone, such as a receiver microphone, as part of the communication device 108A and/or accessory (e.g., headset, etc.). Additionally, or alternatively, the audio input device may be a part of, or built into, the communication device 108A. In some embodiments, the audio input device may be the receiver microphone of the communication device 108A. In some cases, the audio output device may include, but is not limited to speakers, which are part of a headset, standalone speakers or speakers integrated into the communication devices 108A-108N.

The communication network 116 may be packet-switched and/or circuit-switched. An illustrative communication network 116 includes, without limitation, a Wide Area Network (WAN), such as the Internet, a Local Area Network (LAN), a Personal Area Network (PAN), a Public Switched Telephone Network (PSTN), a Plain Old Telephone Service (POTS) network, a cellular communications network, an IP Multimedia Subsystem (IMS) network, a Voice over IP (VoIP) network, a SIP network, or combinations thereof. The Internet is an example of the communication network 116 that constitutes an Internet Protocol (IP) network including many computers, computing networks, and other communication devices located all over the world, which are connected through many telephone systems and other means. In one configuration, the communication network 116 is a public network supporting the TCP/IP suite of protocols. Communications supported by the communication network 116 include real-time, near-real-time, and non-real-time communications. For instance, the communication network 116 may support voice, video, text, web-conferencing, or any combination of media. Moreover, the communication network 116 may include a number of different communication media such as coaxial cable, copper cable/wire, fiber-optic cable, antennas for transmitting/receiving wireless messages, and combinations thereof. In addition, it can be appreciated that the communication network 116 need not be limited to any one network type, and instead may include a number of different networks and/or network types. It should be appreciated that the communication network 116 may be distributed. Although embodiments of the present disclosure will refer to one communication network 116, it should be appreciated that the embodiments claimed herein are not so limited. For instance, more than one communication network 116 may be joined by combinations of servers and networks.

The term “communication device” as used herein is not limiting and may be referred to as a user device and mobile device, and variations thereof. A communication device, as used herein, may include any type of device capable of communicating with one or more of another device and/or across a communications network, via a communications protocol, and the like. A communication device may comprise any type of known communication equipment or collection of communication equipment. Examples of an illustrative communication device may include, but are not limited to, any device with a sound and/or pressure receiver, a cellular phone, a smart phone, a telephone, handheld computers, laptops, netbooks, notebook computers, subnotebooks, tablet computers, scanners, portable gaming devices, pagers, GPS modules, portable music players, and other sound and/or pressure receiving devices. A communication device does not have to be Internet-enabled and/or network-connected. In general, each communication device may provide many capabilities to one or more users who desire to use or interact with the conferencing system 142. For example, a user may access the conferencing system 142 utilizing the communication network 116.

Capabilities enabling the disclosed systems and methods may be provided by one or more communication devices through hardware or software installed on the communication device, such as application 128. For example, the application 128 may be in the form of a communication application and can be used to automatically adjust the volume of an audio signal during a communication session.

In general, each communication device 108A-108N may provide many capabilities to one or more users 104A-104N who desire to interact with the conferencing system 142. Although each communication device 108A-108N is depicted as being utilized by one user, one skilled in the art will appreciate that multiple users may share any single communication device 108A-108N.

In some embodiments, the conferencing system 142 may reside within a server 144. The server 144 may be a server that is administered by an enterprise associated with the administration of communication device(s) or owning communication device(s), or the server 144 may be an external server that can be administered by a third-party service, meaning that the entity which administers the external server is not the same entity that either owns or administers a communication device. In some embodiments, an external server may be administered by the same enterprise that owns or administers a communication device. As one particular example, a communication device may be provided in an enterprise network and an external server may also be provided in the same enterprise network. As a possible implementation of this scenario, the external server may be configured as an adjunct to an enterprise firewall system, which may be contained in a gateway or Session Border Controller (SBC) which connects the enterprise network to a larger unsecured and untrusted communication network. An example of a messaging server is a unified messaging server that consolidates and manages multiple types, forms, or modalities of messages, such as voice mail, email, short-message-service text message, instant message, video call, and the like. As another example, a conferencing server is a server that connects multiple participants to a conference call. As illustrated in FIG. 1, server 144 includes a conferencing system 142, conferencing infrastructure 140, automatic volume adjustment module 148 and database 146.

Although various modules and data structures for disclosed systems and methods are depicted as residing on the server 144, one skilled in the art can appreciate that one, some, or all of the depicted components of the server 144 may be provided by other software or hardware components. For example, one, some, or all of the depicted components of the server 144 may be provided by logic on a communication device (e.g., the communication device may include logic for the systems and methods disclosed herein so that the systems and methods are performed locally at the communication device). Further, the logic of application 128 can be provided on the server 144 (e.g., the server 144 may include logic for the systems and methods disclosed herein so that the systems and methods are performed at the server 144). In embodiments of the present disclosure, the server 144 can perform the methods disclosed herein without use of logic on any communication devices 108A-108N.

The conferencing system 142 implements functionality for the systems and methods described herein by interacting with two or more of the communication devices 108A-108N, application 128, conferencing infrastructure 140, automatic volume adjustment module 148 and database 146, and/or other sources of information as discussed in greater detail below that can allow two or more communication devices 108 to participate in a multi-party call. In some embodiments of the present disclosure the automatic volume adjustment module can also be part of the conferencing system application executing on the user's device. One example of a multi-party call includes, but is not limited to, a person-to-person call, a conference call between two or more users/parties, and the like. Although some embodiments of the present disclosure are discussed in connection with multi-party calls, embodiments of the present disclosure are not so limited. Specifically, the embodiments disclosed herein may be applied to one or more of audio, video, multimedia, conference calls, web conferences, and the like.

In some embodiments of the present disclosure, the conferencing system 142 can include one or more resources such as conferencing infrastructure 140 as discussed in greater detail below. As can be appreciated, the resources of the conferencing system 142 may depend on the type of multi-party call provided by the conferencing system 142. Among other things, the conferencing system 142 may be configured to provide conferencing of at least one media type between any number of participants. The conferencing infrastructure 140 can include hardware and/or software resources of the conferencing system 142 that provide the ability to hold multi-party calls, conference calls, and/or other collaborative communications.

In some embodiments of the present disclosure, the automatic volume adjustment module 148 may be used to adjust the volume of the audio signals from the conference call based on a user's preference. As discussed in greater detail below, the automatic volume adjustment module 148 includes several components, including an audio analyzer and an audio adjuster. In various embodiments of the present disclosure, settings (e.g., volume level settings or thresholds) may be configured and changed by any users and/or administrators of the communication system 100. Settings may be configured to be personalized in any manner (e.g., for a device or user), and may be referred to as profile settings. According to one embodiment of the present disclosure, the user can select from various pre-recorded audio samples with varying levels of speech intensities fed into the system that the system allows the user to select, which are then set into the user's profile.

The database 146 may include information pertaining to one or more of the users 104A-104N, communication devices 108A-108N, and conferencing system 142, among other information. For example, the database 146 can include settings for personalized automatic volume adjustment related to thresholds, communication devices, users, and applications.

The conferencing infrastructure 140 and the automatic volume adjustment module 148 may allow access to information in the database 146 and may collect information from other sources for use by the conferencing system 142. In some instances, data in the database 146 may be accessed utilizing the conferencing infrastructure 140, the automatic volume adjustment module 148 and the application 128 running on one or more communication devices, such as communication devices 108A-108N.

Application 128 may be executed by one or more communication devices (e.g., communication devices 108A-108N) and may execute all or part of conferencing system 142 at one or more of the communication device(s) 108A-108N by accessing data in database 146 using the conferencing infrastructure 140 and the automatic volume adjustment module 148. Accordingly, a user may utilize the application 128 to access and/or provide data to the database 146. For example, a user 104A may utilize application 128 executing on communication device 108A to adjust the volume for audio signals for each of the other participants during the conference call using volume level settings entered by the user 104A. If the detected voice levels of one or more participants exceed a certain level, the automatic volume adjustment module 148 adjusts the volume to the level set by the user 104A. Such data may be received at the conferencing system 142 and associated with one or more profiles associated with the user 104A and the other participants to the conference call 104B to 104N and stored in database 146.

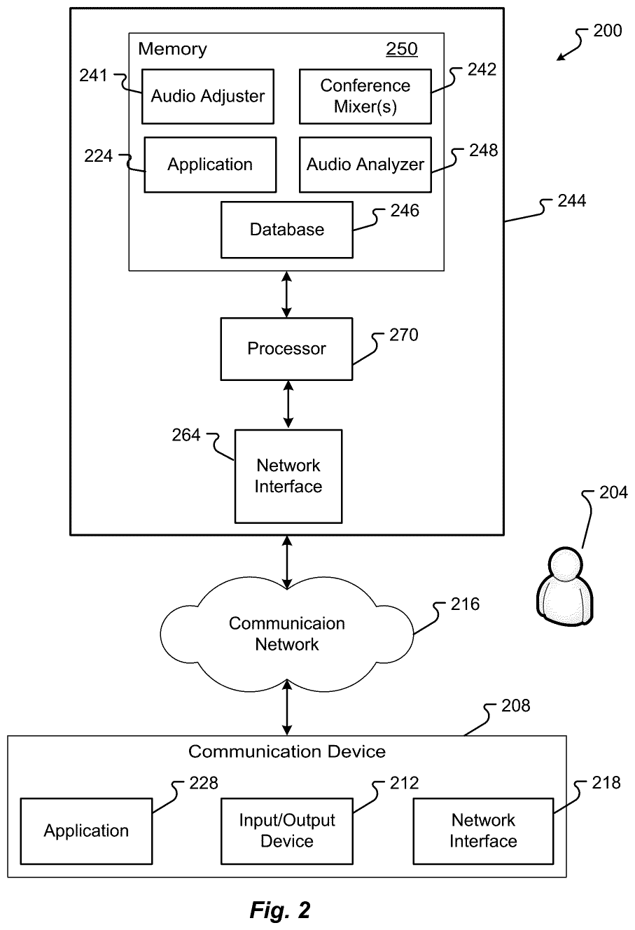

FIG. 2 is a block diagram of an illustrative conferencing server 244 used for automatic volume adjustment during a communication session according to embodiments of the present disclosure. Referring to FIG. 2, a communication system 200 is illustrated in accordance with at least one embodiment of the present disclosure. The communication system 200 may allow users such as user 204 to participate in a conference call with other users (not shown) using a communication device 208. The conferencing server 244 implements functionality establishing the conference call for the systems and methods described herein by interacting with the communication devices (including its hardware and software components) and the various components of the conferencing server 244. For example, the conferencing server 244 includes a memory 250 and a processor 270. Furthermore, the conferencing server 244 includes a network interface 264. The memory 250 includes a database 246, an application 224 (used in conjunction with application 128 of the communication devices 108A-108N), conference mixer(s) 242 (part of the conferencing infrastructure 140 illustrated in FIG. 1) and an audio analyzer 248 and an audio adjuster 241 (each component being part of the automatic volume adjustment module 148 illustrated in FIG. 1).

The processor 270 may include a microprocessor, Central Processing Unit (CPU), a collection of processing units capable of performing serial or parallel data processing functions, and the like. The memory 250 may include a number of applications or executable instructions that are readable and executable by the processor 270. For example, the memory 250 may include instructions in the form of one or more modules and/or applications. The memory 250 may also include data and rules in the form of threshold setting that can be used by one or more of the modules and/or applications described herein. The memory 250 may also include one or more communication applications and/or modules, which provide communication functionality of the conferencing sever 244. In particular, the communication application(s) and/or module(s) may contain the functionality necessary to enable the conferencing server 244 to communicate with communication device 208 as well as other communication devices (not shown) across the communication network 216. As such, the communication application(s) and/or module(s) may have the ability to access communication preferences and other settings, maintained within database 246 and/or memory 250), format communication packets for transmission via the network interface 264, as well as condition communication packets received at network interface 264 for further processing by the processor 270.

Among other things, the memory 250 may be used to store instructions, that when executed by the processor 270 of the communication system 200, perform the methods as provided herein. In some embodiments of the present disclosure, one or more of the components of the communication system 200 may include a memory 250. In one example, each component in the communication system 200 may have its own memory 250. Continuing this example, the memory 250 may be a part of each component in the communication system 200. In some embodiments of the present disclosure, the memory 260 may be located across the communication network 216 for access by one or more components in the communication system 200. In any event, the memory 250 may be used in connection with the execution of application programming or instructions by the processor 270, and for the temporary or long-term storage of program instructions and/or data. As examples, the memory 250 may comprise RAM, DRAM, SDRAM, or other solid-state memory. Alternatively, or in addition, the memory 250 may be used as data storage and can comprise a solid-state memory device or devices. Additionally, or alternatively, the memory 250 used for data storage may include a hard disk drive or other random-access memory. In some embodiments of the present disclosure, the memory 250 may store information associated with a user, a timer, rules, recorded audio information, notification information, and the like. For instance, the memory 250 may be used to store predetermined speech characteristics, private conversation characteristics, information related to mute activation/deactivation, times associated therewith, combinations thereof, and the like.

The network interface 264 includes components for connecting the conferencing server 244 to communication network 216. In some embodiments of the present disclosure, a single network interface 264 connects the conferencing server 244 to multiple networks. In some embodiments of the present disclosure, a single network interface 264 connects the conferencing server 244 to one network and an alternative network interface is provided to connect the conferencing server 244 to another network. The network interface 264 may comprise a communication modem, a communication port, or any other type of device adapted to condition packets for transmission across a communication network 216 to one or more destination communication devices (not shown), as well as condition received packets for processing by the processor 270. Examples of network interfaces include, without limitation, a network interface card, a wireless transceiver, a modem, a wired telephony port, a serial or parallel data port, a radio frequency broadcast transceiver, a USB port, or other wired or wireless communication network interfaces.

The type of network interface 264 utilized may vary according to the type of network which the conferencing server 244 is connected, if at all. Exemplary communication networks 216 to which the conferencing server 244 may connect via the network interface 264 include any type and any number of communication mediums and devices which are capable of supporting communication events (also referred to as “phone calls,” “messages,” “communications” and “communication sessions” herein), such as voice calls, video calls, chats, emails, TTY calls, multimedia sessions, or the like. In situations where the communication network 216 is composed of multiple networks, each of the multiple networks may be provided and maintained by different network service providers. Alternatively, two or more of the multiple networks in the communication network 216 may be provided and maintained by a common network service provider or a common enterprise in the case of a distributed enterprise network.

The conference mixer(s) 242 as well as other conferencing infrastructure can include hardware and/or software resources of the conferencing system that provide the ability to hold multi-party calls, conference calls, and/or other collaborative communications. As can be appreciated, the resources of the conferencing system may depend on the type of multi-party call provided by the conferencing system. Among other things, the conferencing system may be configured to provide conferencing of at least one media type between any number of participants. The conference mixer(s) 242 may be assigned to a particular multi-party call for a predetermined amount of time. In one embodiment of the present disclosure, the conference mixer(s) 242 may be configured to negotiate codecs with each communication device 108 participating in a multi-party call. Additionally, or alternatively, the conference mixer(s) 242 may be configured to receive inputs (at least including audio inputs) from each participating communication device 108 and mix the received inputs into a combined signal which can be provided to each communication device 108 in the multi-party call.

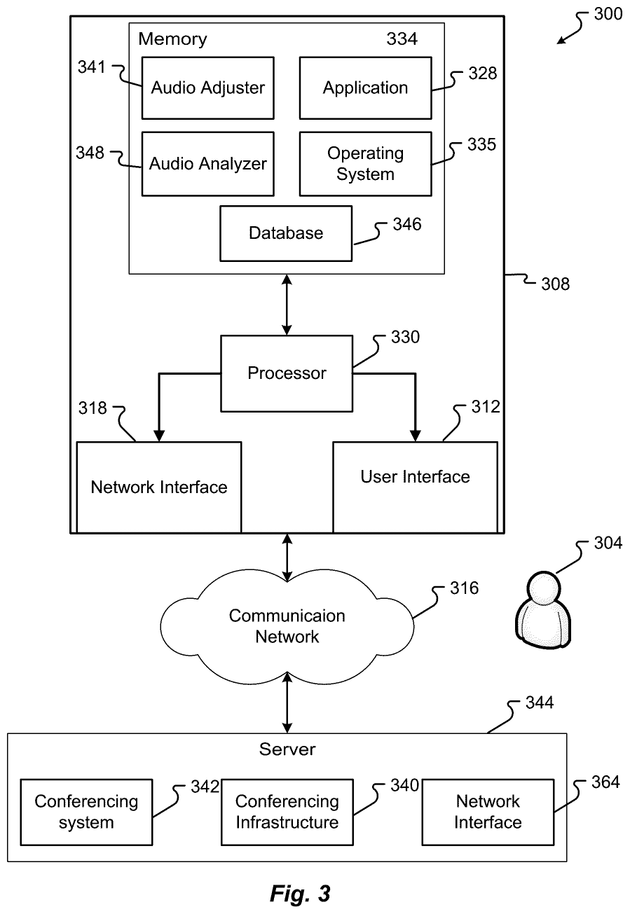

The audio analyzer 248 is used to identify an incoming audio volume level of other participants to the communication session. The audio analyzer 248 identifies the decibel level of the volume of the incoming audio signals. According to embodiments of the present disclosure as discussed later in FIG. 3, the audio analyzer 248 may also be provided on communication device 208 and part of application 128 (e.g., a conferencing application). When an audio signal is transmitted from input/output devices such as microphones or speakers and received in digital format by the communication device 308, the audio signal is converted from digital to analog sound waves by a digital to analog converter (not shown). The converted audio signal is then analyzed for volume decibel levels. According to an alternative embodiment of the present disclosure as illustrated in FIG. 2, the volume level identification occurs at the conferencing server 244 or through a service hosted in a cloud environment that the conferencing server 244 would invoke.

The audio adjuster 241 is an automatic volume manipulator. According to embodiments of the present disclosure, the audio adjuster 241 receives input from the audio analyzer 248 and a volume level selection from user 204 as discussed in greater detail below. Similar to the audio analyzer 248, the audio adjuster 241 may be provided on the conferencing server 244 as illustrated or on the communication device 208 (not shown). The volume level of the incoming audio signal is compared with the set volume level, and if there are any differences found between the two volume levels, the audio adjuster 241 adjusts the volume level of the incoming audio signal to the set volume level.

The communication system 200 further includes the communication device 208 which includes application 288, input/output device 212 and network interface 218. A further description of communication device 208 is provided in FIG. 3.

FIG. 3 is a block diagram of an illustrative communication device 308 used for automatic volume adjustment during a communication session according to embodiments of the present disclosure. A system 300 including the communication device 308 capable of allowing a user 304 to interact with conferencing server 344 is shown in FIG. 3. The depicted communication device 308 includes a processor 330, memory 334, a user interface 312, a network interface 318, a database 346, an operating system 335, application 328, audio adjuster 341 and audio analyzer 348. Although the details of only one communication device 308 are depicted in FIG. 3, one skilled in the art will appreciate that one or more other communication devices may be equipped with similar or identical components as the communication device 308 depicted in detail. Components shown in FIG. 3 may correspond to those shown and described in FIGS. 1 and 2.

The user interface 312 can enable user 304 or multiple users to interact with the communication device 308. Exemplary user input devices which may be included in the user interface 312 include, without limitation, a button, a mouse, trackball, rollerball, image capturing device, or any other known type of user input device. Exemplary user output devices which may be included in the user interface 318 include without limitation, a speaker, light, Light Emitting Diode (LED), display screen, buzzer, or any other known type of user output device. In some embodiments of the present disclosure, the user interface 312 includes a combined user input and user output device, such as a touchscreen. Using user interface 312, user 304 may configure settings via the application 328 for setting threshold values for volume selections.

The processor 330 may include a microprocessor, Central Processing Unit (CPU), a collection of processing units capable of performing serial or parallel data processing functions, and the like. The processor 330 interacts with the memory 334, user interface 312, and network interface 318, and may perform various functions of the application 328, the audio adjuster 341 and the audio analyzer 348.

The memory 334 may include a number of applications or executable instructions that are readable and executable by the processor 330. For example, the memory 334 may include instructions in the form of one or more modules and/or applications. The memory 334 may also include data and rules in the form of one or more settings for thresholds that can be used by the application 328, the audio adjuster 341, the audio analyzer 348, and the processor 330.

The operating system 335 is a high-level application which enables the various other applications and modules to interface with the hardware components (e.g., processor 330, network interface 318 and user interface 312 of the communication device 308. The operating system 335 also enables user 304 or other users (not shown in FIG. 3) of the communication device 308 to view and access applications and modules in memory 334 as well as any data, including settings. In addition, the application 328 may enable other applications and modules to interface with hardware components of the communication device 308.

The audio adjuster 341, the audio analyzer 348 and the application 328 provide some or all functionality of automatic volume adjustment as described herein, and the audio adjuster 341, the audio analyzer 348 and the application 328 can interact with other components to perform the functionality of automatic volume adjustment, as described herein. In particular, the audio adjuster 341 and the audio analyzer 348 may contain the functionality necessary to enable the communication device 308 to monitor sounds and adjust the sound based on a user's volume selection.

According to embodiments of the present disclosure, the conferencing system provides an automatic adjustment feature to a user, such as user 304. User 304 is able to activate/deactivate (e.g., turn ON and turn OFF) the automatic volume adjustment feature using user interface 312. According to embodiments of the present disclosure, user interface 312 may take the form of a toggle button or any other interface discussed above.

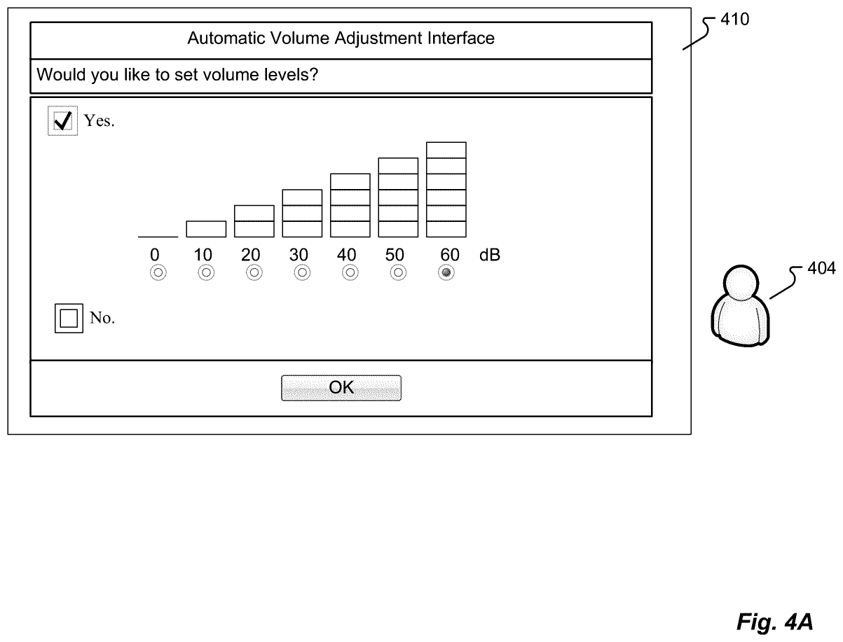

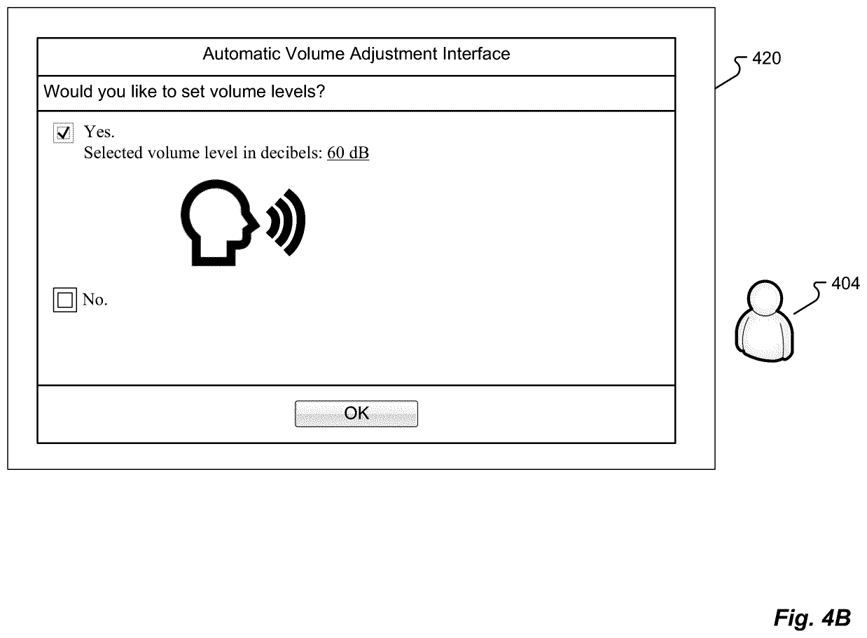

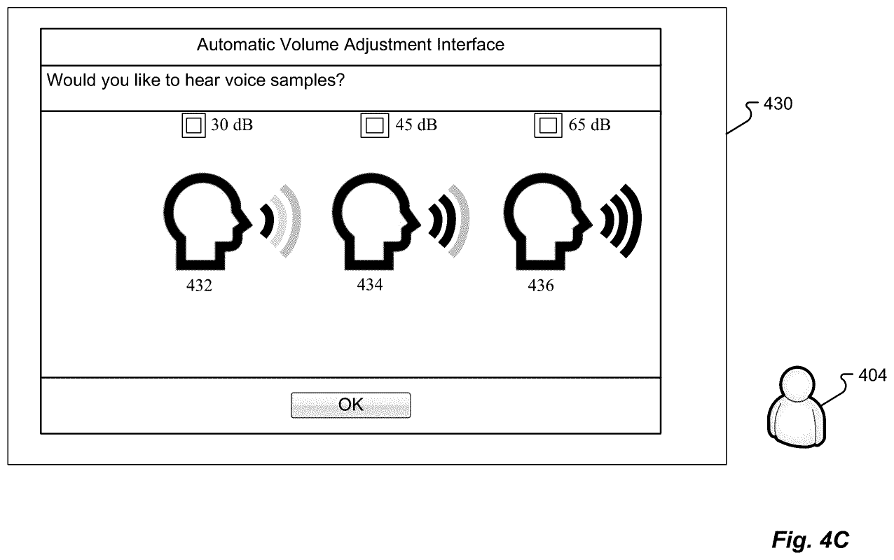

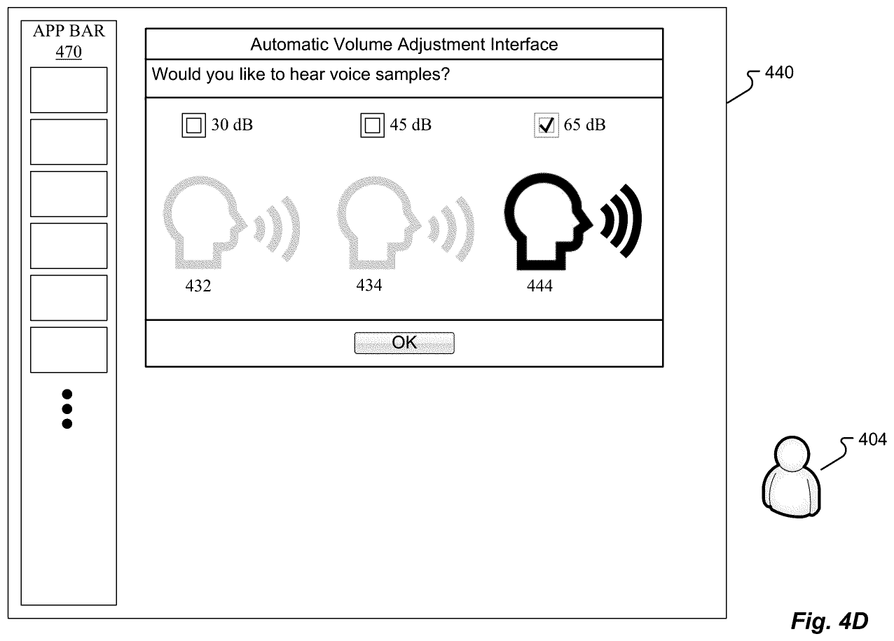

Referring back to FIG. 3, if user 304 turns ON the automatic volume adjustment feature of communication device 308, user interface 312 (e.g., a display) prompts the user to provide a volume level that user 304 is comfortable with during the communication session. This volume level would be delivered to the user at the selected volume level in a consistent manner. FIG. 4A illustrates an automatic volume adjustment interface 410 that can be displayed on communication device 308 used for automatic volume adjustment during a communication session according to embodiments of the present disclosure. As illustrated in FIG. 4A, user 404 is asked “Would you like to set volume levels?” User 404 is also given the options of selecting “Yes” or “No” to the question. If user 404 selects “Yes”, user 404 is provided a slide bar for the user to select a volume level. The user moves the slide bar across the various decibel levels (e.g., 0 dB to 60 dB to select a desired volume level. Generally, human speech ranges from 30 decibels to 65 decibels. Accordingly, user 404 would need to know how a particular decibel level will sound (e.g., the user needs to know how a particular decibel level actually maps to audio loudness or the intensity level).

FIG. 4B illustrates an automatic volume adjustment interface 420 that can be displayed on communication device 308. As illustrated in FIG. 4B, user 404 selects the “Yes” option and selects 60 decibels (dB) as the selected volume level. After selecting the volume level, user 404 is provided with a sound at that volume level. For example, user 404 is provided with the sound of a bell ringing or the sound of an automated human voice at the entered volume level to confirm that this is the volume level at which user 404 wants to conduct the communication session. On the other hand, if user 404 is unfamiliar with volume levels (e.g., decibel ranges), user 404 may be provided with audio samples in automated human voices. Although a particular graphical element is illustrated in the figures for a user to select a desired volume level, other graphical elements such as a slide bar or a touch screen with buttons and arrows to increase or decrease the volume level, for example, can be used without departing from the spirit and the scope of the present disclosure.

As illustrated in FIG. 4C, automatic volume adjustment interface 430 asks user 404, “Would you like to hear voice samples?” User 404 is also provided with a voice sample at 30 dB, icon 432, a voice sample at 45 dB, icon 434 and voice sample at 65 dB, icon 436. User 404 can activate (e.g., listen to) each of the voice samples by clicking on the corresponding icon before making a selection. FIG. 4D illustrates an automatic volume adjustment interface 440 that can be displayed on communication device 308. As illustrated in FIG. 4D, user 404 selects sample automated human voice 444 which represents an automated human voice at 65 decibels.

Referring back to FIG. 3, the audio analyzer 348 is used to identify an incoming audio volume level of other participants to the communication session. The audio analyzer 348 identifies the decibel level of the volume of the incoming audio signals. The audio analyzer 348 may be part of application 328 (e.g., a conferencing application). The audio analyzer 348 may also interface with the audio/sound drivers of operating system 335 through appropriate Application Programming Interface (API)s in order to identify the audio signal volume levels. According to an alternative embodiment of the present disclosure, the audio analyzer may also interface with some other component deployed remotely, e.g., in a cloud environment in order to identify and adjust the volume of the incoming audio signal. According to one embodiment of the present disclosure, the audio signal volume levels refer to a mixed signal from the other users to the communication session mixed by conference mixer(s) 242 illustrated in FIG. 2. According to an alternative embodiment of the present disclosure, the audio signal volume level refers to each of the individual user's audio signal.

When an audio signal is transmitted from input/output devices such as microphones or speakers and received in digital format by the communication device 308, the audio signal is converted from digital to analog sound waves by a digital to analog converter (not shown). The converted audio signal is then analyzed for volume decibel levels. According to an alternative embodiment of the present disclosure as illustrated in FIG. 2, the volume level identification occurs at the audio analyzer 248, 348 or through a service hosted in a cloud environment that the conferencing server 244 would invoke.

The audio adjuster 341 is an automatic volume manipular. According to embodiments of the present disclosure, the audio adjuster 341 receives input from the audio analyzer 348 and a volume level selection from user 304 as discussed above. Similar to the audio analyzer 348, the audio adjuster 341 may be provided on the conferencing server 344 as illustrated or on the communication device 308. The volume level of the incoming audio signal is compared with the set volume level, and if there are any differences found between the two volume levels, the audio adjuster 341 adjusts the volume level of the incoming audio signal to the set volume level. According to embodiments of the present disclosure, the software volume control support provided by the operating system 335 and audio drivers can be utilized to enhance the automatic volume adjustment feature. The software volume control support is provided for audio hardware that either does not include an amplifier with an associated physical volume control or the audio volume is controlled entirely through software without the need to control volume through physical amplifiers that would require manual intervention.

According to one embodiment of the present disclosure, application 328 (e.g., a conferencing application) is used. Accordingly, application 328 controls the volume of the incoming audio signal without manual intervention based on the differences between the volume level of the incoming audio signal and the volume level set by the user. In order to achieve this, the audio drivers will expose various APIs that application 328 will interface with (i.e., application 328 will use an appropriate volume adjustment API that is exposed by the audio driver/operating system software component and achieve auto volume adjustment.

Although some applications and modules may be depicted as software instructions residing in memory 334 and those instructions are executable by the processor 330, one skilled in the art will appreciate that the applications and modules may be implemented partially or totally as hardware or firmware. For example, an Application Specific Integrated Circuit (ASIC) may be utilized to implement some, or all of the functionality discussed herein.

Although various modules and data structures for disclosed systems and methods are depicted as residing on the communication device 308, one skilled in the art can appreciate that one, some, or all of the depicted components of the communication device 308 may be provided by other software or hardware components. For example, one, some, or all of the depicted components of the communication device 308 may be provided by systems operating on conferencing server 344. In the illustrative embodiments shown in FIG. 3, the communication device 308 includes all the necessary logic for the systems and methods disclosed herein so that the systems and methods are performed at the communication device 308. Thus, the communication device 308 can perform the methods disclosed herein without use of logic on conferencing server 344.

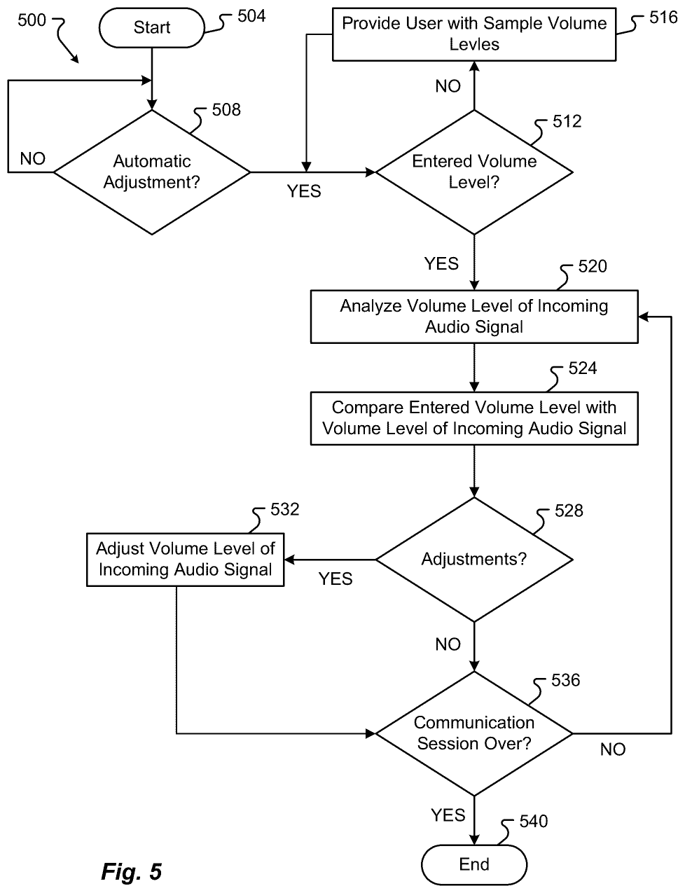

FIG. 5 is a flow diagram of a method 500 used for automatic volume adjustment during a communication session according to embodiments of the present disclosure. While a general order of the steps of method 500 is shown in FIG. 5, method 500 can include more or fewer steps or can arrange the order of the steps differently than those shown in FIG. 5. Further, two or more steps may be combined into one step. Generally, method 500 starts with a START operation at step 504 and ends with an END operation at 540. Method 500 can be executed as a set of computer-executable instructions executed by a data-processing system and encoded or stored on a computer readable medium. Hereinafter, method 500 shall be explained with reference to systems, components, modules, software, data structures, user interfaces, etc. described in conjunction with FIGS. 1-4D.

Method 500 starts with the START operation at step 504 and proceeds to decision step 508, where the processor 330 of the communication device 308 determines if the automatic volume adjustment feature has been activated. If the automatic volume adjustment feature has not been activated (NO) at decision step 508, method 500 returns to decision step 508 to determine if the automatic volume adjustment feature has been activated. If the automatic volume adjustment feature has been activated (YES) at decision step 508, method 500 proceeds to decision step 512, where the processor 330 of the communication device 308 determines if a volume level has been entered. If a volume level has not been entered (NO) at decision step 512, method 500 proceeds to step 516, where the processor 330 of the communication device 308 provides the user with sample volume levels. After providing the user with sample volume levels at step 516, method 500 returns to decision step 512 to determine if a volume level has been entered. If a volume level has been entered (YES) at decision step 512, method 500 proceeds to step 520 where the processor 330 of communication device 308 analyzes the volume level of an incoming audio signal. After analyzing the volume level of an incoming audio signal at step 520, method 500 proceeds to step 524, where the processor 330 of the communication device 308, compares the entered volume level with the volume level of the incoming audio signal. After comparing the entered volume level with the volume level of the incoming audio signal at step 524, method 500 proceeds to decision step 528, where the processor 330 of the communication device 308 determines if an adjustment to the volume level of the incoming audio signal needs to be made based on the comparison between the entered volume level and the volume level of the incoming audio signal. According to embodiments of the present disclosure, an adjustment is made to the incoming audio signal if the entered volume level does not match the volume level of the incoming audio signal. For example, if the entered volume level is 65 decibels and the volume level of the incoming audio signal is 60 decibels, the volume level of the incoming audio signal would be adjusted by +5 decibels to 65 decibels. On the other hand, if the volume level of the incoming audio signal is 75 decibels and the entered volume level is 65 decibels, the volume level of the incoming audio signal would be adjusted by −10 decibels to 65 decibels.

If there is no adjustment to the incoming audios signal (NO) at decision step 528, method 500 proceeds to decision step 536, where the processor 330 of the communication device 308 determines if the communication session has been completed. If the communication session has been completed (YES) at decision step 536, method 500 ends at END operation 540. If the communication session has not been completed (NO) at decision step 536, method 500 returns to step 520 where the processor 330 of the communication device 308 analyzes the volume level of an incoming audio signal. If there is an adjustment to the incoming audio signal (YES) at decision step 528, method 500 proceeds to step 532, where the processor 330 of the communication device 308 adjusts the volume level of the incoming audio signal. After the volume level of the incoming audio signal has been adjusted at step 532, method 500 proceeds to decision step 536 where the processor 330 of the communication device 308 determines if the communication session has been completed. If the communication session has been completed (YES) at decision step 536, method 500 ends at END operation 540. If the communication session has not been completed (NO) at decision step 536, method 600 returns to step 520 where the processor 330 of the communication device 308 analyzes the volume level of an incoming audio signal.

Any of the steps, functions, and operations discussed herein can be performed continuously and automatically.

The exemplary systems and methods of this disclosure have been described in relation to communication devices, multiple-device environments, and a distributed processing network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein. For instance, while described in conjunction with client-server networks (e.g., conferencing servers, client devices, etc.), it should be appreciated that the components, systems, and/or methods described herein may be employed as part of a peer-to-peer network or other network. As can be appreciated, in a peer-to-peer network, the various components or systems described in conjunction with the communication system may be part of one or more endpoints, or computers, participating in the peer-to-peer network.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital communications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a communications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development locations that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges, or steps to those claimed, whether or not such alternate, interchangeable and/or equivalent structures, functions, ranges or steps are disclosed herein, and without intending to publicly dedicate any patentable subject matter.

Embodiments of the present disclosure include a method. The method includes receiving, by a processor, an entered volume level, receiving, by the processor, at least one audio signal from a communication session and analyzing, by the processor, a volume level of the at least one audio signal. The method also includes comparing, by the processor, the entered volume level with the volume level of the at least one audio signal and determining, by the processor, that the entered volume level does not match the volume level of the at least one audio signal. When the entered volume level does not match the volume level of the at least one audio signal, adjusting, by the processor, the volume level of the at least one audio signal to match the entered volume level.

Aspects of the above method include wherein the communication session is a conference call.

Aspects of the above method further include receiving, by the processor, the entered volume level based on a sample selection of volume levels.

Aspects of the above method further include generating, by the processor, a graphical illustration for the sample selection of volume levels.

Aspects of the above method further include generating, by the processor, corresponding sounds for each of the sample selection of volume levels.

Aspects of the above method include wherein the volume level of the at least one audio signal includes loudness, pitch, range, intensity, and tone data associated with the at least one audio signal.

Aspects of the above method include wherein the entered volume level is measured in decibels.

Aspects of the above method further include storing the entered volume level in a user profile.

Aspects of the above method include wherein the communication session is one of a voice communication and a video communication.

Embodiments of the present disclosure include a system. The system includes a processor and a memory coupled with and readable by the processor and having stored therein a set of instructions which, when executed by the processor, causes the processor to: receive an entered volume level. The processor is also caused to receive at least one audio signal from a communication session and analyze a volume level of the at least one audio signal. The processor is further caused to compare the entered volume level with the volume level of the at least one audio signal and determine that the entered volume level does not match the volume level of the at least one audio signal. When the entered volume level does not match the volume level of the at least one audio signal, the processor is further caused to adjust the volume level of the at least one audio signal to match the entered volume level.

Aspect of the above system include wherein the communication session is a conference call.

Aspect of the above system include wherein the volume level of the at least one audio signal includes loudness, pitch, range, intensity, and tone data associated with the at least one audio signal.

Aspect of the above system include wherein the entered volume level is measured in decibels.

Aspect of the above system include wherein the processor is further caused to store the entered volume level in a user profile.

Aspect of the above system include wherein the communication session is one of a voice communication and a video communication.

Embodiments of the present disclosure include a tangible and non-transitory computer readable medium including microprocessor executable instructions that, when executed by the microprocessor, perform the functions of receiving an entered volume level, receiving at least one audio signal from a communication session, analyzing a volume level of the at least one audio signal, comparing the entered volume level with the volume level of the at least one audio signal and determining that the entered volume level does not match the volume level of the at least one audio signal. When the entered volume level does not match the volume level of the at least one audio signal, a further function is performed of adjusting the volume level of the at least one audio signal to match the entered volume level.

Aspects of the above computer readable medium include wherein the communication session is a conference call.

Aspects of the above computer readable medium include wherein the volume level of the at least one audio signal includes loudness, pitch, range, intensity, and tone data associated with the at least one audio signal.

Aspects of the above computer readable medium include wherein the entered volume level is measured in decibels.

Aspects of the above computer readable medium include wherein the microprocessor further performs the function of storing the entered volume level in a user profile.

Any one or more of the aspects or embodiments as substantially disclosed herein optionally in combination with any one or more other aspects/embodiments as substantially disclosed herein.

One or means adapted to perform any one or more of the above aspects or embodiments as substantially disclosed herein.

Methods described or claimed herein can be performed with traditional executable instruction sets that are finite and operate on a fixed set of inputs to provide one or more defined outputs. Alternatively, or additionally, methods described or claimed herein can be performed using AI, machine learning, neural networks, or the like. In other words, a system or server is contemplated to include finite instruction sets and/or artificial intelligence-based models/neural networks to perform some or all of the steps described herein.

What is claimed is:

1. A method, comprising:
receiving, by a processor, an entered volume level;
receiving, by the processor, at least one audio signal from a communication session;
analyzing, by the processor, a volume level of the at least one audio signal;
comparing, by the processor, the entered volume level with the volume level of the at least one audio signal;
determining, by the processor, that the entered volume level does not match the volume level of the at least one audio signal; and
when the entered volume level does not match the volume level of the at least one audio signal, adjusting, by the processor, the volume level of the at least one audio signal to match the entered volume level.

2. The method according to claim 1, wherein the communication session is a conference call.

3. The method according to claim 1, further comprising receiving, by the processor, the entered volume level based on a sample selection of volume levels.

4. The method according to claim 3, further comprising generating, by the processor, a graphical illustration for the sample selection of volume levels.

5. The method according to claim 3, further comprising generating, by the processor, corresponding sounds for each of the sample selection of volume levels.

6. The method according to claim 1, wherein the volume level of the at least one audio signal includes loudness, pitch, range, intensity, and tone data associated with the at least one audio signal.

7. The method according to claim 1, wherein the entered volume level is measured in decibels.

8. The method according to claim 1, further comprising, storing the entered volume level in a user profile.

9. The method according to claim 1, wherein the communication session is one of a voice communication and a video communication.

10. A system, comprising:
a processor; and
a memory coupled with and readable by the processor and having stored therein a set of instructions which, when executed by the processor, causes the processor to:
receive an entered volume level;
receive at least one audio signal from a communication session;
analyze a volume level of the at least one audio signal;
compare the entered volume level with the volume level of the at least one audio signal;
determine that the entered volume level does not match the volume level of the at least one audio signal; and
when the entered volume level does not match the volume level of the at least one audio signal, adjust the volume level of the at least one audio signal to match the entered volume level.

11. The system according to claim 10, wherein the communication session is a conference call.

12. The system according to claim 10, wherein the volume level of the at least one audio signal includes loudness, pitch, range, intensity, and tone data associated with the at least one audio signal.

13. The system according to claim 10, wherein the entered volume level is measured in decibels.

14. The system according to claim 10, wherein the processor is further caused to store the entered volume level in a user profile.

15. The system according to claim 10, wherein the communication session is one of a voice communication and a video communication.

16. A tangible and non-transitory computer readable medium comprising microprocessor executable instructions that, when executed by the microprocessor, perform the following functions:
receiving an entered volume level;
receiving at least one audio signal from a communication session;
analyzing a volume level of the at least one audio signal;
comparing the entered volume level with the volume level of the at least one audio signal;
determining that the entered volume level does not match the volume level of the at least one audio signal; and
when the entered volume level does not match the volume level of the at least one audio signal, adjusting the volume level of the at least one audio signal to match the entered volume level.

17. The computer readable medium according to claim 16, wherein the communication session is a conference call.

18. The computer readable medium according to claim 16, wherein the volume level of the at least one audio signal includes loudness, pitch, range, intensity, and tone data associated with the at least one audio signal.

19. The computer readable medium according to claim 16, wherein the entered volume level is measured in decibels.

20. The computer readable medium according to claim 16, wherein the microprocessor further performs the function of storing the entered volume level in a user profile.
